(19) United States
(12) Patent Application Publication
(10) Pub. No.: US 2024/0404280 A1
(43) Pub. Date: Dec. 5, 2024

(54) Video and Media Messaging Content Analysis

(71) Applicant: Apple Inc., Cupertino, CA (US)

(72) Inventors: Benjamin H Roos, San Jose, CA (US); Sasanka T Vemuri, San Ramon, CA (US); Mathew R Cruz, San Jose, CA (US); David S Evans, San Ramon, CA (US); Yaseen Mahmoud, Cupertino, CA (US)

(73) Assignee: Apple Inc., Cupertino, CA (US)

(21) Appl. No.: 18/328,750

(22) Filed: Jun. 4, 2023

(51) Int. Cl. G06V 20/40; G06F 3/0482; G06F 3/0484; G06V 10/774; G06V 10/778; H04L 51/212

(52) U.S. Cl. CPC G06V 20/41; G06F 3/0482; G06F 3/0484; G06V 10/774; G06V 10/7788; H04L 51/212

(57) ABSTRACT

In some embodiments, a computing device is configured to analyze media mail for sensitive content, prior to exposing a user of the computing device to the content of the media mail. The computing device receives a media mail targeting a user of the computing device. The computing device analyzes a first set of media content of the media mail to determine whether the first set of media content meets a first set of sensitivity criteria. Responsive to determining that the first set of media content meets the first set of sensitivity criteria, the computing device displays an alert notifying the user of the sensitive content. Subsequent to displaying the alert, the computing device receives user input approving playback of the first set of media content and initiates the playback of the first set of media content on the computing device responsive to receiving the user input.

### TECHNICAL FIELD

The disclosure generally relates to analyzing the content of video and media messages, and more specifically to a machine learning model trained to recognize and alert a user to sensitive content in a media message.

### BACKGROUND

Video and media messaging allows a sender to create a media message that can include sounds, video, images, animation, moving images, etc., in place of or in addition to text and/or voice messages. The media message may be sent to one or more recipient devices for viewing by users of these recipient devices, rather than simply reading text or listening to an audio message. However, these media messages may include content that would be deemed sensitive, offensive, and/or vulgar to the user when viewing the content on one of the recipient devices.

### OVERVIEW

In some implementations, a computing device is configured to analyze media mail for sensitive content, prior to exposing a user of the computing device to the content of the media mail. The computing device receives a media mail targeting a first user of the computing device, with the media mail including a first set of media content. The computing device analyzes the first set of media content to determine whether the first set of media content meets a first set of one or more sensitivity criteria or not. Responsive to determining that the first set of media content meets the first set of one or more sensitivity criteria, the computing device displays a first alert associated with the first set of one or more sensitivity criteria (e.g., alerting the user of the sensitive content). Subsequent to displaying the first alert, the computing device receives user input approving playback of the first set of media content and initiates the playback of the first set of media content on the computing device responsive to receiving the user input. Otherwise, the computing device refrains from playing back the media mail.

In some implementations, a server device is configured to analyze media mail for sensitive content, prior to sending the media mail to a recipient device or playing back the media mail for a user of the recipient device. The server device obtains a media mail targeting a first user of the recipient device, with the media mail including a first set of media content. The server device analyzes the first set of media content to determine whether the first set of media content meets a first set of one or more sensitivity criteria or not. Responsive to determining that the first set of media content does not meet the first set of one or more sensitivity criteria, the server device sends the media mail to the recipient device or plays back the media mail for the user of the recipient device. Responsive to determining that the first set of media content meets the first set of one or more sensitivity criteria, the server device sends a first alert associated with the first set of one or more sensitivity criteria (e.g., alerting the user of the sensitive content) to the recipient device for display to the user. Subsequent to sending the first alert, the server device receives user input from the recipient device indicating approval or disapproval of playing back the media mail. Responsive to receiving approval, the server device initiates the playback of the first set of media content on the recipient device or sends the media mail to the recipient device. Responsive to receiving disapproval, the server device discards the media mail.

In one or more embodiments, a sending device is configured to generate and/or obtain a media mail, and analyze the media mail for sensitive content prior to sending the media mail to a recipient device or a server device for delivery to the recipient device. The sending device analyzes a first set of media content of the media mail to determine whether the first set of media content meets a first set of one or more sensitivity criteria or not. Responsive to determining that the first set of media content does not meet the first set of one or more sensitivity criteria, the sending device sends the media mail to the recipient device or the server device. The media mail may be sent in addition to metadata or some other indication of the media mail not including sensitive content, such as a certificate or token. Responsive to determining that the first set of media content meets the first set of one or more sensitivity criteria, the sending device sends a first alert associated with the first set of one or more sensitivity criteria (e.g., alerting the user of the sensitive content) to the recipient device for display to the user. Subsequent to sending the first alert, the sending device receives user input from the recipient device indicating approval or disapproval of playing back the media mail. Responsive to receiving approval, the sending device delivers the media mail to the recipient device for playback thereon. Responsive to receiving disapproval, the sending device refrains from delivering the media mail.

Particular implementations provide at least the following advantages. A user of a recipient device is notified of potentially sensitive content prior to being exposed to the content in a media message. The media message may be received as a result of an unanswered call, and therefore may be already distrusted by the user. Therefore, the user is able to determine whether to view the media mail with greater appreciation of an potentially sensitive content therein, so that any viewing may be performed in a safer environment and/or avoided altogether.

Details of one or more implementations are set forth in the accompanying drawings and the description below. Other features, aspects, and potential advantages will be apparent from the description and drawings, and from the claims.

### DESCRIPTION OF DRAWINGS

FIG. 1A is a block diagram of an example system.

FIG. 1B is a block diagram of an example recipient device.

FIG. 2 is a flow diagram of an example process of a recipient device analyzing media mail for sensitive content in one or more embodiments.

FIG. 3 is a flow diagram of an example process of a server device analyzing media mail for sensitive content in one or more embodiments.

FIG. 4 is a flow diagram of an example process of a sending device analyzing media mail for sensitive content in one or more embodiments.

FIGS. 5A-5D show example user interfaces for media message content analysis functionality, in one or more embodiments.

FIG. 6 is a block diagram of an example computing device that can implement the features and processes of FIGS. 1-5D.

Like reference symbols in the various drawings indicate like elements.

### DETAILED DESCRIPTION

### Media Message Content Analysis System

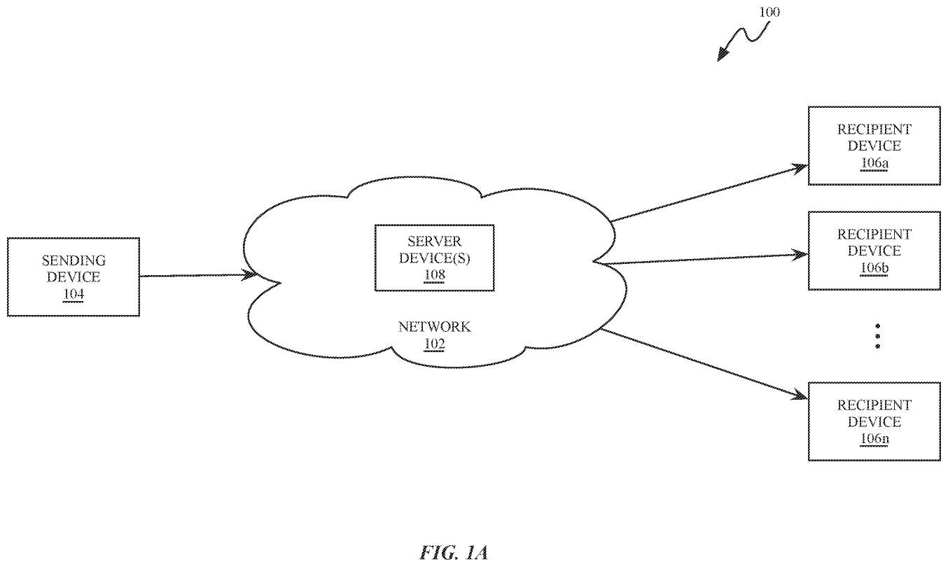

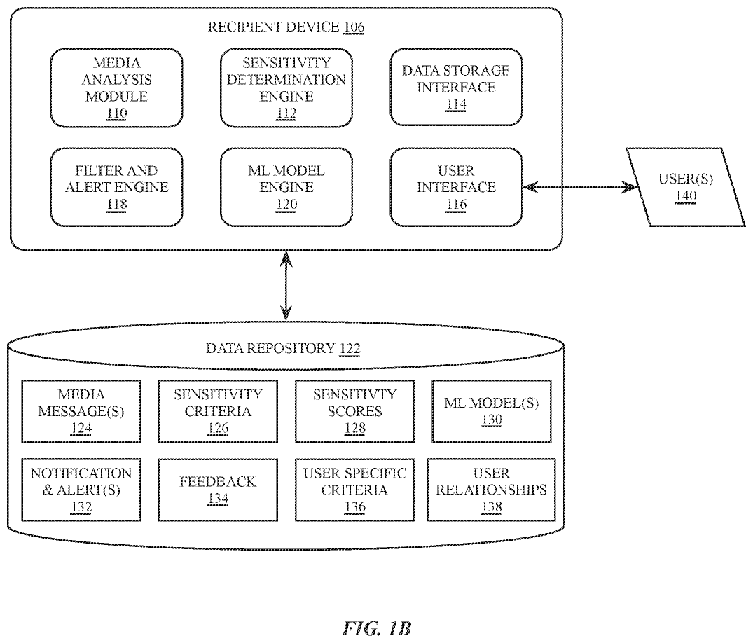

FIG. 1A is a block diagram of an example system 100. System 100 includes a network 102 that electronically connects a sending device 104 with at least one recipient device 106 (e.g., recipient device 106a, recipient device 106b, . . . recipient device 106n). A recipient device 106 may be any type of computing device comprising a hardware processor that is capable of connecting to the network 102 and playing back a media message triggered by the sending device 104. Some example recipient devices 106 include, but are not limited to, a smartphone, tablet computer, laptop computer, smartwatch, virtual reality (VR) headset, augmented reality (AR) headset, smart home device, etc. Any number of recipient devices 106 may be connected to the network 102 and receive media messages resulting from user input on the sending device 104.

System 100 includes at least one sending device 104, and in some approaches, multiple sending devices 104 may be present in system 100, some of which may also function as recipient devices 106. The sending device 104 may be any type of computing device having a hardware processor configured to receive user input for generation of a media message and connect to the network 102. In one approach, the sending device 104 may generate a media message based on user input (such as video recording using a smartphone, audio recording using a smartwatch, etc.). In another approach, sending device 104 may obtain user input and deliver the user input to a server device 108 in network 102 for generation of a media message. Some example sending devices 104 include, but are not limited to, a smartphone, tablet computer, laptop computer, smartwatch, VR/AR headset, smart home device, etc.

FIG. 1B is a block diagram of an example recipient device 106 that may be used in system 100 of FIG. 1A. Recipient device 106 includes a set of modules and/or processes configured for performing one or more functions for analyzing the content of media messages, which are described below.

Recipient device 106 includes a media analysis module 110, sensitivity determination engine 112, data storage interface 114, filter and alert engine 118, machine learning (ML) model engine 120, and user interface 116. A data repository 122 is electronically coupled to recipient device 106 via data storage interface 114 for storing data to data repository 122 and for retrieving data from data repository 122. In an approach, recipient device 106 comprises data repository 122. In an alternate approach, data repository 122 may be located proximate to or remote from recipient device 106.

Data repository 122 may be used to store information and/or data for recipient device 106 and may be any type of storage unit and/or device (e.g., a file system, database, collection of tables, or any other storage mechanism) for storing data. Further, data repository 122 may include multiple different storage units and/or devices. The multiple different storage units and/or devices may or may not be of the same type or located at the same physical site. Further, data repository 122 may be implemented or may execute on the same computing system as recipient device 106. Alternatively or additionally, data repository 122 may be implemented or executed on a computing system separate from recipient device 106. Data repository 122 may be communicatively coupled to any device for transmission and receipt of data via a direct connection or via a network, such as network 102.

Data repository 122 is shown having a set of data in one or more embodiments. More or less data may be stored in data repository 122 at any given time, depending on requests from recipient device 106. In one embodiment, data repository 122 may store one or more media messages received from sending device 104. A media message may include any type of media object that is playable by an intended recipient device 106, such as a multimedia message, media mail, video mail, video chat request, animated message, etc. These media messages may include audio and/or video content. A media message may have any length; however, many media messages will be relatively short in length (e.g., less than 1 minute).

A media message 124 may include any combination of text, audio, video, images, animation, and moving images intended for one or more specified users. In other words, a media message 124 may be a multimedia presentation designed for playback on various recipient devices 106 that are associated with the one or more specified users.

Because a media message, and particularly media mail, targets one or more specific users, the media message may be accessed and/or viewed on any device associated with the specific users. Media mail does not designate any particular device for playback thereon in one approach.

As recipient device 106 receives a media message 124, prior to playback thereof, recipient device 106 may store the received media message 124 to data repository 122 for content analysis and/or subsequent playback.

In one approach, sending device 104 may encrypt at least a portion of the media mail prior to transmitting the media mail to recipient device 106. In some embodiments, one or more intermediate devices (e.g., server device(s) 108) may not be able to access contents of the media mail. In this approach, recipient device 106 decrypts the encrypted data object received from sending device 104 to obtain the media mail.

In one embodiment, data repository 122 may store sensitivity criteria 126 for analyzing received media messages 124 by the media analysis module 110. Sensitivity criteria 126 may be generated by recipient device 106 (e.g., by the sensitivity determination engine 112), in one approach, based on a set of rules or guidelines for how to analyze media messages 124 for sensitive content. In other approach, sensitivity criteria 126 may be received from another device (e.g., a server device) and applied globally across a set of recipient devices 106.

In one or more embodiments, media analysis module 110 may use sensitivity criteria 126 on recipient device 106 to analyze a media message 124 to determine whether media content of the media message 124 comprises sensitive content (e.g., vulgar content, nudity, adult-rated content, violent content, hateful speech or actions, discriminatory content, misogynistic content, and/or some other user-specified sensitive content). The sensitivity criteria 126 may include identification of one or more certain content types, such as words that may be sensitive when written or spoken, body parts that may be sensitive to view or discuss, topics that may be sensitive to a user, themes that may be sensitive to a user, etc. For example, sensitivity criteria 126 may indicate that any media message 124 that includes words that would cause a movie to receive a Motion Picture Association rating of R or higher should be indicated as sensitive during analysis. In another example, sensitivity criteria 126 may indicate that any media message 124 that includes real life violence toward women should be indicated as sensitive during analysis.

In another approach, sensitivity criteria 126 may include thresholds for certain content types, such as a number of certain words spoken, a number of times that a body part is shown, type(s) of body parts shown, a volume in which certain words are audible in the media message 124, a clarity for shown images (e.g., whether the certain image is in focus and clear to a user), etc. For example, sensitivity criteria 126 may indicate that any media message 124 that includes one depiction of violence toward animals should be indicated as sensitive during analysis. In another example, sensitivity criteria 126 may indicate that any media message 124 that includes three depictions of cartoon violence should be indicated as sensitive during analysis.

Because some users may have more tolerance for certain kinds of sensitive content (e.g., violence, profanity, etc.), a user may specific their own user-specified sensitivity criteria 136, which may be based on a global set of sensitivity criteria or originally created/specified by the user, in one or more embodiments. This set of user-specified sensitivity criteria 136 may be used in place of sensitivity criteria 126, or in conjunction with sensitivity criteria 126 in various approaches.

Media analysis module 110 is configured to generate and utilize sensitivity criteria 126 and/or user-specified sensitivity criteria 136 when determining whether a media message 124 includes sensitive content, in one or more embodiments. Media analysis module 110 may analyze a set of media content from one or more media messages 124 to determine whether the set of media content meets at least one of the sensitivity criteria 126 and/or user-specified sensitivity criteria 136. Moreover, media analysis module 110 may execute one or more ML models 130 generated by ML model engine 120 in performing the media content analysis.

In one embodiment, data repository 122 may store sensitivity scores 128 that are generated by the ML model engine 120 for use with one or more ML models 130. The sensitivity scores 128 represent, in a quantitative way, the level of sensitive content that is included in a media message 124. The scores may be normalized to a certain scale (e.g., −1 to 1, 0 to 1, 0 to 100, etc.) in an embodiment. This allows for the ML model engine 120 to specify a threshold sensitivity score for an ML model 130, in which any media message 124 that has a sensitivity score that exceeds the threshold sensitivity score is marked as having sensitive content, and any media message 124 that has a sensitivity score that does not exceed the threshold sensitivity score is marked as not having sensitive content.

In one embodiment, data repository 122 may store one or more notifications and/or alerts 132 for display to the user(s) 140 via user interface 116 on recipient device 106. The notifications and/or alerts 132 may be generated and/or selected from possible notifications/alerts by filter and alert engine 118. Filter and alert engine 118 is configured to display, via user interface 116, an appropriate notification and/or alert in response to a determination by media analysis module 110 that a media message 124 includes sensitive content. Moreover, in some approaches, filter and alert engine 118 may filter out any media messages that meet one or more sensitivity criteria 126 and/or 136 from being viewed or notified to the user 140 of recipient device 106 automatically. In an approach, the filtering functionality of filter and alert engine 118 may be configured by media analysis module 110 and/or an ML model 130 to filter out extremely sensitive media messages 124, such as media messages 124 that include content that exceeds a threshold number of sensitivity criteria 126 and/or 136, such as three or four (e.g., nudity, vulgarity, profanity, and violence).

The notifications and/or alerts 132 may include banners, pop-up windows, items to add to a notification list, lock screen interface elements, etc. One or more of these notifications and/or alerts 132 may include text and/or graphics that describe or alert a user 140 to the presence of potentially sensitive content in a media message 124, such that the user 140 may determine whether to playback the media message 124 or not prior to being exposed to the content of the media message 124. The notifications and/or alerts 132 may include user-selectable interface elements that will perform a certain task when selected. For example, a banner notification may include two interface elements, one to accept playback of the media message, and one to decline playback of the media message.

In one embodiment, data repository 122 may store feedback 134 from user 140 interactions with outcomes provided by the media message content analysis ML model 130. For example, if a user 140 chooses to playback media messages 124 that include profanity, but not media messages 124 that include violence, the ML model engine 120 will receive this feedback 134 and modify the ML model 130 operating on recipient device 106 to account for these user 140 actions in relation to the sensitivity scores 128 that are assigned to certain kinds of sensitive content.

In one embodiment, data repository 122 may store one or more user relationships 138 that may define how the media analysis module 110 performs the media content analysis and utilizes the sensitivity criteria 126 and/or user-specified sensitivity criteria 136 to determine whether a media message 124 includes sensitive content. For example, a certain sending device may be flagged as having sent media message(s) 124 with sensitive content in the past. Therefore, any further media messages 124 form this particular sending device may be marked as potentially including sensitive content. In another example, a media message sent by a person for which there is information stored in a contacts database of the recipient device 106 may bypass analysis for sensitive content, and/or have less restrictive sensitivity criteria applied during the content analysis of the media message 124 due to the relationship between the user 140 and the stored contact.

Although the various components are illustrated and described in relation to a particular recipient device 106, any device within the ecosystem may implement any of the components. For example, media content analysis may be implemented by a server device that performs the media content analysis before sending a media message from a sending device to the recipient device 106. In another example, media content analysis may be implemented by the sending device that performs media content analysis before the media message is sent out from the sending device to recipient device 106.

### ML Model for Computing Sensitivity Scores

In one embodiment, recipient device may train a ML model based on training data to compute sensitivity scores for sets of content. In this embodiment, supervised learning is used to provide input and a corresponding label to train a neural network.

Once the neural network is trained, the resultant ML model is applied to a target input (e.g., a media message received at a recipient device 106) for the ML model to compute corresponding output(s), such as a sensitivity determination for content of the media message, a sensitivity score for the media message, etc.

The training data may include, as an example, a first training dataset that includes a particular set of media content and a label indicating a sensitivity score corresponding to the particular set of media content. For example, training data may include a media clip of a comic performing a routine that includes multiple instances of swearing and a label indicating a sensitivity score related to inclusion of multiple instances of swearing. This sensitivity score may be greater than a sensitivity score for a media mail that includes a single instance of swearing. Moreover, identification of different swear words may result in different sensitivity scores based on the severity of the word.

In another example, training data may include an image of nudity and a label indicating a sensitivity score related to inclusion of nudity. Moreover, the sensitivity score associated with a video of nudity may be greater than a sensitivity score associated with a single image of nudity.

In another example, training data may include a video of a user showing obscene gestures to the viewer and a label indicating a sensitivity score related to inclusion of vulgar or obscene imagery. Moreover, the sensitivity score associated with multiple instances of obscene gestures may be greater than a sensitivity score associated with a single instance of obscene gesturing.

Moreover, when utilizing a ML model for content analysis, recipient device may receive, from the first user, feedback for the first set of media content and update the ML model based on the feedback for the first set of media content. This feedback may include indication that a sensitive content determination was incorrect, indication that the first set of media content included sensitive content that was not indicated by the ML model, other acts associated with the media mail (discarding, opening, responding, etc.), user actions associated with a sender of the media mail (e.g., blocking, adding to contacts list, etc.), positive or negative indications about the categorization for sensitive content in the first set of media content, etc.

In this way, an ML model may be used for analyzing media mail for sensitive content and learn over time to be more accurate in predictions of media messages including sensitive content or not.

### ML Model for Computing Sensitivity Criteria

In one embodiment, recipient device may train a ML model based on training data to compute sets of sensitivity criteria for users. In this embodiment, the ML model may be trained to generate sensitivity criteria that may be used by the ML model to determine sensitive content in a media message, and/or for a rules-based system to determine sensitive content in a media message.

The training data may include, as an example, (a) a first training dataset that includes a first plurality of sets of content, (b) an approval or disapproval indication (by a particular user) for each particular set of media content in the first plurality of sets of content indicating whether the particular user approved or disapproved of the particular set of media content in the first plurality of sets of content, and (c) a label, associated with the particular user, defining a particular set of one or more sensitivity criteria for the particular user.

Each combination of (a) sets of similar content, (b) approval/disapproval, and (c) label defining the particular set of one or more sensitivity criteria may be used to train the ML model repeatedly until the ML model is able to correctly identify each combination correctly.

For example, a training dataset may include, as content in each set of content, different representations of nudity that have been disapproved by a user, and a label indicating unacceptable nudity as the sensitive criterion.

In another example, a training dataset may include, as content in each set of content, obscene language that has been disapproved by a user, and a label indicating obscene language as the sensitive criterion.

In yet another example, a training dataset may include, as content in each set of content, a comedian performing a routine without foul language that has been approved by a user, and a label indicating no sensitive criterion.

In an example, a training dataset may include, as content in each set of content, different representations of nudity that have been approved by a user, and a label indicating acceptable nudity as the sensitive criterion.

The recipient device applies the machine learning model to a target dataset (such as a combination of the intended recipient and media message), associated with the user of the recipient device, to compute the first set of one or more sensitivity criteria. In this approach, the target dataset includes a second plurality of sets of content and an approval or disapproval indication, by the user, for each particular set of media content in the second plurality of sets of content indicating whether the first user approved or disapproved of the particular set of media content in the second plurality of sets of content. Also, recipient device receives feedback, for the first set of media content, from the user that includes one of an approval or disapproval for the first set of media content and updates the ML model based on the feedback for the first set of media content.

In this way, an ML model may be used to generate and modify the sets of sensitivity criteria through learning based on feedback from the user of the recipient device in respect to decisions regarding sensitive content being included in media messages.

### Example Processes

To enable the reader to obtain a clear understanding of the technological concepts described herein, the following processes describe specific steps performed in a specific order. However, one or more of the steps of a particular process may be rearranged and/or omitted while remaining within the contemplated scope of the technology disclosed herein. Moreover, different processes, and/or steps thereof, may be combined, recombined, rearranged, omitted, and/or executed in parallel to create different process flows that are also within the contemplated scope of the technology disclosed herein. Additionally, while the processes below may omit or briefly summarize some of the details of the technologies disclosed herein for clarity, the details described in the paragraphs above may be combined with the process steps described below to get a more complete and comprehensive understanding of these processes and the technologies disclosed herein.

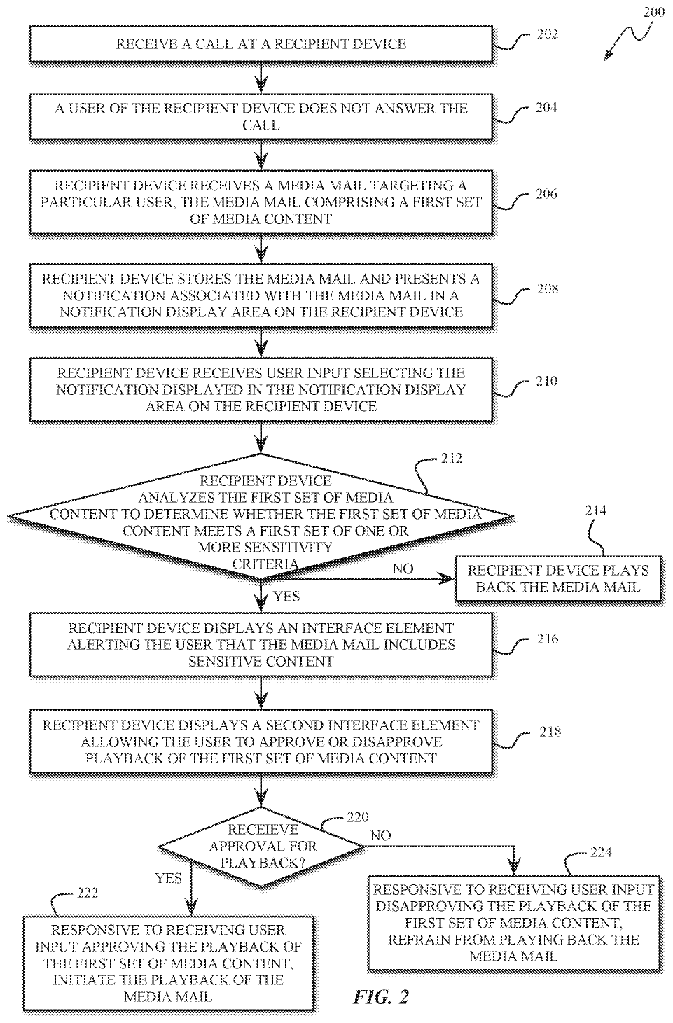

FIG. 2 is a flow diagram of an example process 200 of a recipient device analyzing media messages for sensitive content in one or more embodiments. More or less operations than those shown and described herein may be included in process 200 in various approaches. For the remainder of the description of FIG. 2, process 200 will be described as being performed by a recipient device having at least one hardware processor for performing the various operations.

In operation 202, a recipient device receives a call (e.g., from a sending device) over one or more mobile networks. The call may be a telephone call to be received by a receiver device at the recipient device, a video chat request using a video chat application executing on the recipient device, a multimedia message sent to the recipient device which may include a link to open content or a chat portal, or some other request to initiate a communications channel between the sending device and the recipient device. In one embodiment, the

In operation 204, a user of the recipient device does not answer the call (or otherwise initiate the communications channel with the sending device). This may be due to the user not wishing to take the call, being busy when the call came in, not being the intended recipient of the call based on some displayed information (e.g., caller ID, intended recipient person for the call), not hearing or being alerted to the call, not having the recipient device in proximity to take the call, etc.

In operation 206, recipient device receives a media mail targeting a particular user of the recipient device. The media mail includes a first set of media content. A media mail may include any type of media object that is playable by recipient device in an approach. A media mail may include any combination of text, audio, video, images, animation, and moving images. In one approach, the media mail is a recording, made by the sending device, of a sender of the media mail.

Although the media mail targets the particular user of the recipient device, any user using the recipient device may have access to the media mail, in one or more approaches.

In one embodiment, a second device (e.g., sending device) generates the first set of media content at least by recording sound and/or video detected by the second device subsequent to a call by the second device to the recipient device being unanswered, and transmits the first set of media content in the media mail to the recipient device.

In one approach, the second device may encrypt the media mail prior to transmitting the media mail to the recipient. In some embodiments, one or more intermediate devices (e.g., a server device) may not be able to access the content of the media mail. In this approach, recipient device decrypts the encrypted data object received from the second device to obtain the media mail.

In operation 208, recipient device stores the media mail to a data repository accessible to the recipient device and presents a notification on a display of the recipient device associated with the media mail. This notification, in one approach, may be presented in a notification display area of the recipient device.

The notification display area may include other message-type notifications that are generated by the recipient device, such as voicemail(s) received and/or unselected, text message(s) received and/or unread, emails received and/or unread, etc. In a further approach, the notification display area may include one or more other types of notifications, such as tasks to perform, calendar events upcoming, reminders, battery level alerts, system notifications, etc.

In operation 210, recipient device receives user input selecting the notification associated with the media mail that is displayed in the notification display area of the recipient device. This selection may be via touch input on a touchscreen device, voice input (e.g., asking an artificial intelligence (AI) service on the recipient device to select the notification), input via one or more physical interface elements of the recipient device (e.g., physical button, slider, toggle switch, etc.), a visual indication of the user (e.g., the user looking at the notification for a threshold amount of time triggering the recipient device to open the media mail), etc.

In one embodiment, the user may select the notification directly from the notifications display area of the recipient device. In another embodiment, the user may select the media mail through some other menu, list, or interface element present on the display of the recipient device or a related device (such as a wearable device, laptop computer, tablet computer, etc.) that are all capable of displaying the media mail.

In operation 212, recipient device analyzes the first set of media content to whether that the first set of media content meets a first set of one or more sensitivity criteria. In an approach, analyzing the first set of media content to determine whether the first set of media content meets the first set of one or more sensitivity criteria includes analyzing the first set of media content to determine at least one of: that the first set of media content comprises vulgar content, that the first set of media content comprises nudity, that the first set of media content comprises adult-rated content, and/or that the first set of media content comprises user-specified sensitive content.

The analysis of the media mail for sensitive content may be performed at any time after the media mail is received at the recipient device, and is not necessarily in response to receiving user input selecting the notification associated with the media mail, in one or more approaches.

In one embodiment, operation 212 may include applying a trained ML model to the first set of media content to compute a sensitivity score for the first set of media content. Moreover, recipient device may determine whether the sensitivity score meets the first set of one or more sensitivity criteria. This allows for quantitative analysis of the sensitive content of the media mail.

Moreover, in an embodiment, a trained ML model may be used to generate and modify the sets of sensitivity criteria through learning based on feedback from the user of the recipient device in respect to decisions regarding sensitive content being included in media messages.

In an approach, the first set of one or more sensitivity criteria may be a global sensitivity criteria utilized by a plurality of recipient devices for analyzing respective media mail received at each of the plurality of recipient devices. This global set of sensitivity criteria may be configured by a server device for use by each recipient device across a network, and may be particular to a messaging application executing on each recipient device and/or part of an operating system of each recipient device.

The global sensitivity criteria may be managed and modified based on feedback from various recipient devices. This feedback may include user actions responsive to outcomes and results decided based on the global sensitivity criteria, such as whether users of the recipient devices chose to open sensitive media mail, not open media mail, discard media mail, identification of certain senders who consistently sent sensitive media mail content, etc.

In one embodiment, the first set of one or more sensitivity criteria may be a user-specific sensitivity criteria that is determined by the recipient device for use with the particular user only. In this case, recipient device may determine the first set of one or more sensitivity criteria based on user input selecting one or more attributes of the first set of one or more sensitivity criteria (e.g., thresholds for types of sensitive content, types of sensitive content to include in criteria, types of sensitive content not to include in criteria, etc.).

According to an embodiment, recipient device may compute the first set of one or more sensitivity criteria based on a user relationship between (a) the user of the recipient device, and (b) a second user of a second device (e.g., the sending device) that transmitted the media mail to the recipient device. This relationship may be established based on a contacts list of the recipient device, a black list or blocked list of the recipient device, a contacts database accessible to the recipient device, previous interactions between the users, etc.

In one embodiment, recipient device may compute the first set of or more sensitivity criteria based on whether information associated with the second user, of the second device (e.g., the sending device) that transmitted the first media mail to the recipient device, is included in a contact list stored by the recipient device.

In operation 214, responsive to the first set of media content not meeting a first set of one or more sensitivity criteria (e.g., the media mail does not include sensitive content), recipient device plays back the media mail for the user on at least a display of the recipient device.

In operation 216, responsive to the first set of media content meeting a first set of one or more sensitivity criteria (e.g., the media mail includes sensitive content), recipient device displays an interface element (e.g., an alert, banner, notification, etc.) on the display of recipient device, associated with the first set of one or more sensitivity criteria (e.g., indicating that the media mail includes potentially sensitive content).

In an alternate embodiment, instead of performing operation 216, recipient device may filter out media mail, thereby reducing the likelihood that the user will be exposed to any potentially sensitive content in the media mail (e.g., not notify the user about the media mail, discard media mail from the data repository, etc.). In one embodiment, recipient device may filter media mail and alert the user to the sensitive content in the media mail. According to another embodiment, filtering may be performed in response to the first set of media content including more than a threshold level of sensitive content, thereby rendering the media mail especially sensitive for the user.

In one embodiment, a second alert notification may be sent, by recipient device or server device, to the sending device indicating that the media mail includes sensitive content. This second alert notification may be sent in response to the first set of media content meeting a first set of one or more sensitivity criteria, in response to the recipient device filtering out the media mail, and/or in response to user input requesting that the sending device be notified about the sensitive content in the media mail.

In operation 218, concurrent with and/or subsequent to displaying the interface element on the recipient device alerting the user of the sensitive content in the media mail, recipient device displays one or more selectable interface elements that allow the user to approve or disapprove playback of the media mail. These selectable interface elements may be buttons, toggles, etc., that allow the user to choose whether or not to playback the media mail, with the knowledge that it may include sensitive content.

In operation 220, it is determined whether approval for playback of the media mail has been received by the recipient device from the user. This approval may be received via the second interface element in an approach, via voice input, via motion capture gesturing, touch input accessing the media mail, etc.

In one embodiment, the notification displayed by the recipient device in operation 208 or interface element of operation 216 may include a selectable interface element that authorizes playback of the media mail on the recipient device when selected. In a further approach, the notification or interface element may include a second interface element that disallows the playback of the media mail by the recipient device.

In operation 222, responsive to receiving user input approving the playback of the first set of media content, recipient device initiates the playback of the media mail (including the first set of media content) on the first recipient device.

In another approach, operation 222 may be performed on another device associated with the user. In this approach, the playback of the media mail (including the first set of media content) is initiated on another device responsive to user input received at the recipient device (or at another device).

In operation 224, responsive to receiving user input disapproving the playback of the first set of media content, recipient device refrains from playing back at least the first set of media content on the first recipient device. In a further approach, recipient device refrains from playing back any of the media mail on the first recipient device.

In one embodiment, concurrently with displaying the interface element alerting the user of the potentially sensitive content in the media mail, recipient device may display one or more other user interface elements that allow for user input indicating one or more of: approving the playback of the first set of media content, declining the playback of the first set of media content, discarding the media mail, placing the sending device on a blocked contact list, sending a reply to the sending device, etc.

Recipient device may, in an embodiment, display a notification corresponding to receipt of the media mail by the first recipient device in a list of mail notifications. The list of mail notifications includes notifications associated with one or more of: media mail and voicemail.

In an embodiment, recipient device may display the interface element alerting the user of potentially sensitive content in the media mail in operation 216 in further response to receiving user input selecting the notification displayed on the recipient device in operation 208.

In one or more embodiments, recipient device may receive a second media mail targeting the particular user of the recipient device, with the second media mail including a second set of media content. Recipient device will analyze the second set of media content to determine whether the second set of media content meets the first set of one or more sensitivity criteria, and responsive at least to determining that the second set of media content meets the first set of one or more sensitivity criteria, display a second notification on a display of the recipient device alerting the user of potentially sensitive content in the second media mail. Subsequent to displaying the second notification on the first recipient device, recipient device may receive, from the user, a second user input declining playback of the second set of media content. Responsive to receiving the second user input declining the playback of the first set of media content, recipient device will refrain from initiating the playback of the second set of media content on the display of the recipient device.

According to one approach, a group call or chat may be requested by the sending device. The group call, if left unanswered at more than one recipient device, would generate the same media mail sent from the sending device to multiple recipient devices. In this approach, a second recipient device may receive a second media mail targeting a second user of the second recipient device. The second media mail includes the first set of media content that was included in the media mail received by the recipient device in operation 206. In this approach, second recipient device may analyze the first set of media content to determine whether the first set of media content meets a second set of one or more sensitivity criteria, with the second set of one or more sensitivity criteria being different than the first set of one or more sensitivity criteria. Responsive at least to determining that the first set of media content meets the second set of one or more sensitivity criteria, second recipient device may display a notification on the second recipient device alerting a second user of the second recipient device that the second media mail potentially includes sensitive content. Subsequent to displaying the alert notification, second recipient device may receive, from the second user, user input approving playback of the first set of media content and respond to the is user input by initiating the playback of the first set of media content on the second recipient device.

In this approach, each recipient device may have a distinct set of sensitivity criteria, even if a global set of sensitivity criteria is being applied for all recipient devices, based on the sender of the media mail, the recipient device of the media mail, a relationship between these devices, or some other factor that is taken into consideration when applying the global set of sensitivity criteria.

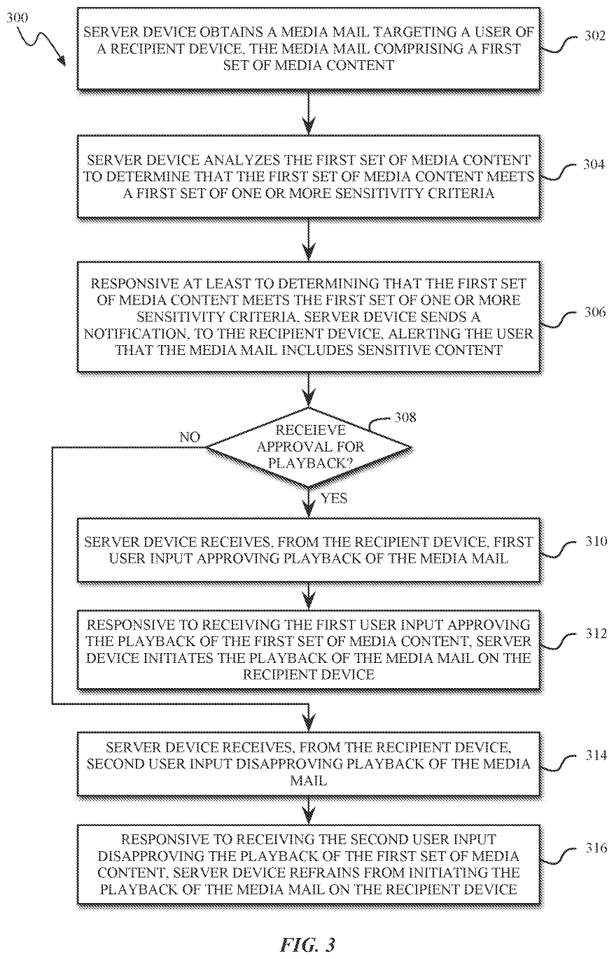

FIG. 3 is a flow diagram of an example process of a server device analyzing media messages for sensitive content in one or more embodiments. More or less operations than those shown and described herein may be included in process 300 in various approaches. For the remainder of the description of FIG. 3, process 300 will be described as being performed by a server device having at least one hardware processor for performing the various operations.

In operation 302, the server device obtains a media mail targeting a particular user of a recipient device. The media mail includes a first set of media content. A media mail may include any type of media object that is playable by recipient device in an approach. A media mail may include any combination of text, audio, video, images, animation, and moving images. In one approach, the media mail is a recording, made by the sending device, of a sender of the media mail.

Although the media mail targets the particular user of the recipient device, any user using the recipient device may have access to the media mail, in one or more approaches.

In one embodiment, a second device (e.g., sending device) generates the first set of media content at least by recording sound and/or video detected by the second device subsequent to a call by the second device to the recipient device being unanswered, and transmits the first set of media content in the media mail to the recipient device.

In one approach, the second device may encrypt the media mail prior to transmitting the media mail to the recipient. In some embodiments, one or more intermediate devices (e.g., the server device) may not be able to access the content of the media mail. In this approach, recipient device decrypts the encrypted data object received from the second device to obtain the media mail.

In operation 304, server device analyzes the first set of media content to whether that the first set of media content meets a first set of one or more sensitivity criteria. In an approach, analyzing the first set of media content to determine whether the first set of media content meets the first set of one or more sensitivity criteria includes analyzing the first set of media content to determine at least one of: that the first set of media content comprises vulgar content, that the first set of media content comprises nudity, that the first set of media content comprises adult-rated content, and/or that the first set of media content comprises user-specified sensitive content for the particular user of the recipient device.

The analysis of the media mail for sensitive content may be performed at any time after the media mail is received at the server device, and is not necessarily in response to any action or trigger. However, in one embodiment, server device may analyze the content of the media mail in response to user input on the recipient device requesting to open the media mail.

In one embodiment, operation 304 may include applying a trained ML model to the first set of media content to compute a sensitivity score for the first set of media content. Moreover, recipient device may determine whether the sensitivity score meets the first set of one or more sensitivity criteria. This allows for quantitative analysis of the sensitive content of the media mail.

Moreover, in an embodiment, a trained ML model may be used to generate and modify the sets of sensitivity criteria through learning based on feedback from the user of the recipient device in respect to decisions regarding sensitive content being included in media messages.

In an approach, the first set of one or more sensitivity criteria may be a global sensitivity criteria utilized by a plurality of recipient devices for analyzing respective media mail designated for each of the plurality of recipient devices. This global set of sensitivity criteria may be configured by the server device for use with media mail designated to users at each recipient device across a network.

The global sensitivity criteria may be managed and modified based on feedback from various recipient devices. This feedback may include user actions responsive to outcomes and results decided based on the global sensitivity criteria, such as whether users of the recipient devices chose to open sensitive media mail, not open media mail, discard media mail, identification of certain senders who consistently sent sensitive media mail content, etc.

In one embodiment, the first set of one or more sensitivity criteria may be a user-specific sensitivity criteria that is determined by feedback provided by the recipient device for use with the particular user only. In this case, server device may determine the first set of one or more sensitivity criteria based on user input selecting one or more attributes of the first set of one or more sensitivity criteria (e.g., thresholds for types of sensitive content, types of sensitive content to include in criteria, types of sensitive content not to include in criteria, etc.).

According to an embodiment, server device may compute the first set of one or more sensitivity criteria based on a user relationship between (a) the user of the recipient device, and (b) a second user of a second device (e.g., the sending device) that transmitted the media mail to the recipient device. This relationship may be established based on a contacts list of the recipient device, a black list or blocked list of the recipient device, a contacts database accessible to the recipient device, previous interactions between the users, etc.

In one embodiment, server device may compute the first set of or more sensitivity criteria based on whether information associated with the second user, of the second device (e.g., the sending device) that transmitted the first media mail to the recipient device, is included in a contact list stored by the recipient device.

In operation 306, responsive at least to determining that the first set of media content meets the first set of one or more sensitivity criteria (e.g., the media mail includes sensitive content), server device sends a notification to the recipient device alerting the user that the media mail includes sensitive content.

In operation 308, server device determines whether approval for playback of the media mail has been received, e.g., via user input at the recipient device. In one embodiment, the notification sent to the recipient device in operation 306 may include a selectable interface element that authorizes transmission of the media mail to the recipient device when selected. In a further approach, the notification may include a second interface element that disallows the delivery of the media mail by the server device.

In operation 310, server device receives first user input approving playback of the media mail from the recipient device. This first user input may be a message sent by recipient device to server device requesting delivery of the media mail, requesting playback of the media mail, etc.

In operation 312, responsive to the server device receiving the first user input approving playback of the media mail from the recipient device, server device initiates playback of the media mail on the recipient device in an approach.

In another approach, server device may deliver media mail to recipient device for playback by the recipient device without further interaction with server device.

In operation 314, server device receives second user input disapproving playback of the media mail from the recipient device. This second user input may be a message sent by recipient device to server device declining delivery of the media mail, declining playback of the media mail, etc.

In operation 316, responsive to the server device receiving the second user input disapproving playback of the media mail from the recipient device, server device refrains from initiating playback of the media mail on the recipient device in an approach.

In another approach, server device may refrain from delivering the media mail to recipient device for playback by the recipient device in response to the second user input.

In an alternate embodiment, instead of performing operation 314, server device may filter out media mail, thereby reducing the likelihood that the user will be exposed to any potentially sensitive content in the media mail (e.g., not notify the user about the media mail, discard media mail from the data repository, etc.). In one embodiment, server device may filter media mail and alert the user to the sensitive content in the media mail. According to another embodiment, filtering may be performed in response to the first set of media content including more than a threshold level of sensitive content, thereby rendering the media mail especially sensitive for the user.

In one embodiment, a second alert notification may be sent, by server device, to the sending device indicating that the media mail includes sensitive content. This second alert notification may be sent in response to the first set of media content meeting a first set of one or more sensitivity criteria, in response to the server device filtering out the media mail, and/or in response to user input requesting that the sending device be notified about the sensitive content in the media mail.

According to one approach, a group call or chat may be requested by the sending device. The group call, if left unanswered at more than one recipient device, would generate the same media mail sent from the sending device to multiple recipient devices. In this approach, a second recipient device may receive a second media mail targeting a second user of the second recipient device. The second media mail includes the first set of media content that was included in the media mail received by the recipient device. In this approach, second recipient device may analyze the first set of media content to determine whether the first set of media content meets a second set of one or more sensitivity criteria, with the second set of one or more sensitivity criteria being different than the first set of one or more sensitivity criteria. Responsive at least to determining that the first set of media content meets the second set of one or more sensitivity criteria, second recipient device may display a notification on the second recipient device alerting a second user of the second recipient device that the second media mail potentially includes sensitive content. Subsequent to displaying the alert notification, second recipient device may receive, from the second user, user input approving playback of the first set of media content and respond to the is user input by initiating the playback of the first set of media content on the second recipient device.

In this approach, each recipient device may have a distinct set of sensitivity criteria, even if a global set of sensitivity criteria is being applied for all recipient devices, based on the sender of the media mail, the recipient device of the media mail, a relationship between these devices, or some other factor that is taken into consideration when applying the global set of sensitivity criteria.

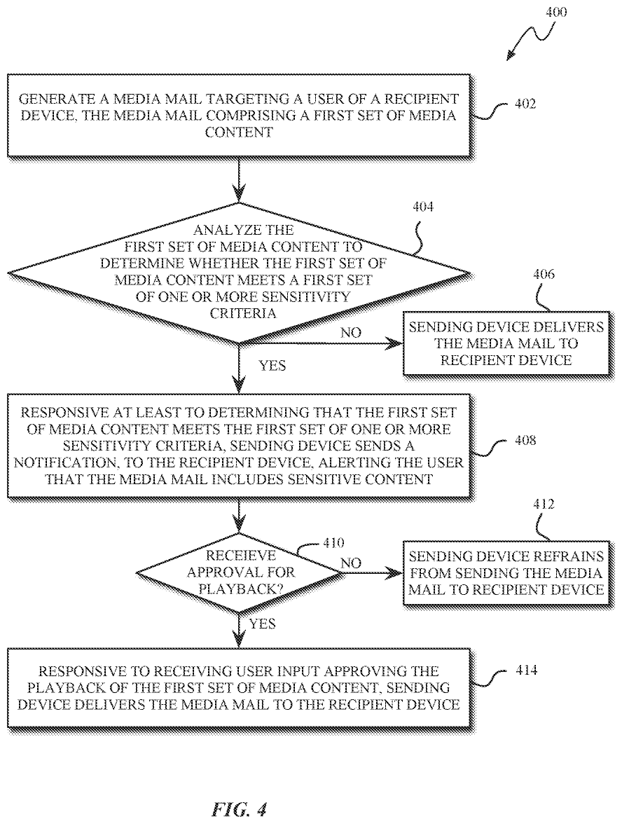

FIG. 4 is a flow diagram of an example process of a sending device analyzing media messages for sensitive content in one or more embodiments. More or less operations than those shown and described herein may be included in process 400 in various approaches. For the remainder of the description of FIG. 4, process 400 will be described as being performed by a sending device having at least one hardware processor for performing the various operations.

In operation 402, the sending device generates and/or obtains a media mail targeting a particular user of a recipient device. The media mail includes a first set of media content. A media mail may include any type of media object that is playable by recipient device in an approach. A media mail may include any combination of text, audio, video, images, animation, and moving images. In one approach, the media mail is a recording, made by the sending device, of a sender of the media mail.

Although the media mail targets the particular user of the recipient device, any user using the recipient device may have access to the media mail, in one or more approaches.

In one embodiment, the sending device generates the first set of media content at least by recording sound and/or video detected by the sending device subsequent to a call by the sending device to the recipient device being unanswered, and transmits the first set of media content in the media mail to the recipient device.

In one approach, the sending device may encrypt the media mail prior to transmitting the media mail to the recipient. In some embodiments, one or more intermediate devices (e.g., a server device) may not be able to access the content of the media mail. In this approach, recipient device decrypts the encrypted data object received from the sending device to obtain the media mail.

In operation 404, sending device analyzes the first set of media content to whether that the first set of media content meets a first set of one or more sensitivity criteria. In an approach, analyzing the first set of media content to determine whether the first set of media content meets the first set of one or more sensitivity criteria includes analyzing the first set of media content to determine at least one of: that the first set of media content comprises vulgar content, that the first set of media content comprises nudity, that the first set of media content comprises adult-rated content, and/or that the first set of media content comprises user-specified sensitive content for the particular user of the recipient device.

The analysis of the media mail for sensitive content may be performed at any time after the media mail is obtained at the sending device, and is not necessarily in response to any action or trigger. However, in one embodiment, sending device may analyze the content of the media mail prior to delivering the media mail to the recipient device responsive to a call being unanswered by the recipient device.

In one embodiment, operation 404 may include applying a trained ML model to the first set of media content to compute a sensitivity score for the first set of media content. Moreover, recipient device may determine whether the sensitivity score meets the first set of one or more sensitivity criteria. This allows for quantitative analysis of the sensitive content of the media mail.

Moreover, in an embodiment, a trained ML model may be used to generate and modify the sets of sensitivity criteria through learning based on feedback from the user of the recipient device in respect to decisions regarding sensitive content being included in media messages.

In an approach, the first set of one or more sensitivity criteria may be a global sensitivity criteria utilized by a plurality of sending devices for analyzing respective media mail designated for each of a plurality of recipient devices. This global set of sensitivity criteria may be configured by the sending device for use with media mail designated to users at each recipient device across a network.

The global sensitivity criteria may be managed and modified based on feedback from various recipient devices. This feedback may include user actions responsive to outcomes and results decided based on the global sensitivity criteria, such as whether users of the recipient devices chose to open sensitive media mail, not open media mail, discard media mail, identification of certain senders who consistently sent sensitive media mail content, etc.

In one embodiment, the first set of one or more sensitivity criteria may be a user-specific sensitivity criteria that is determined by feedback provided by the recipient device for use with the particular user only. In this case, sending device may determine the first set of one or more sensitivity criteria based on user input selecting one or more attributes of the first set of one or more sensitivity criteria (e.g., thresholds for types of sensitive content, types of sensitive content to include in criteria, types of sensitive content not to include in criteria, etc.).

According to an embodiment, sending device may compute the first set of one or more sensitivity criteria based on a user relationship between (a) the user of the recipient device, and (b) a second user of the sending device that transmitted the media mail to the recipient device. This relationship may be established based on a contacts list of the sending device, a black list or blocked list of the sending device, a contacts database accessible to the sending device, previous interactions between the users, etc.

In one embodiment, sending device may compute the first set of or more sensitivity criteria based on whether information associated with the particular user, of the recipient device, is included in a contact list stored by the sending device.

In operation 406, responsive at least to determining that the first set of media content does not meet the first set of one or more sensitivity criteria (e.g., the media mail does not include sensitive content), sending device delivers the media mail to the recipient device, where the recipient device is able to playback the media mail.

In some embodiments, the sending device may deliver the media mail in conjunction with metadata or some other indication that the media mail does not include sensitive content, such as a certificate or token.

In operation 408, responsive at least to determining that the first set of media content meets the first set of one or more sensitivity criteria (e.g., the media mail includes sensitive content), sending device sends a notification to the recipient device alerting the user that the media mail includes sensitive content.

In operation 410, sending device determines whether approval for playback of the media mail has been received, e.g., from the recipient device. This user input may be a message sent by recipient device to sending device requesting delivery of the media mail, requesting playback of the media mail, etc.

In one embodiment, the notification sent to the recipient device in operation 408 may include a selectable interface element that authorizes transmission of the media mail to the recipient device when selected. In a further approach, the notification may include a second interface element that disallows the delivery of the media mail by the sending device.

In operation 412, responsive to not receiving authorization for playback of the media mail, the sending device refrains from delivering the media mail to the recipient device, in an approach.

In one embodiment, server device may discard media mail, thereby reducing the likelihood that the user will be exposed to any potentially sensitive content in the media mail (e.g., not notify the user about the media mail, discard media mail from the data repository, etc.).

In operation 414, responsive to the sending device receiving the user input approving playback of the media mail from the recipient device, sending device delivers the media mail to the recipient device for playback thereon, in an approach.

In one embodiment, a second alert notification may be received, by sending device, indicating that the recipient device disapproves of delivery of the media mail. This second alert notification may be sent in response to the notification that the first set of media content meets a first set of one or more sensitivity criteria.

According to one approach, a group call or chat may be requested by the sending device. The group call, if left unanswered at more than one recipient device, would generate the same media mail sent from the sending device to multiple recipient devices. In this approach, a second recipient device may receive a second media mail targeting a second user of the second recipient device. The second media mail includes the first set of media content that was included in the media mail received by the recipient device. In this approach, second recipient device may analyze the first set of media content to determine whether the first set of media content meets a second set of one or more sensitivity criteria, with the second set of one or more sensitivity criteria being different than the first set of one or more sensitivity criteria. Responsive at least to determining that the first set of media content meets the second set of one or more sensitivity criteria, second recipient device may display a notification on the second recipient device alerting a second user of the second recipient device that the second media mail potentially includes sensitive content. Subsequent to displaying the alert notification, second recipient device may receive, from the second user, user input approving playback of the first set of media content and respond to the is user input by initiating the playback of the first set of media content on the second recipient device.

In this approach, each recipient device may have a distinct set of sensitivity criteria, even if a global set of sensitivity criteria is being applied for all recipient devices, based on the sender of the media mail, the recipient device of the media mail, a relationship between these devices, or some other factor that is taken into consideration when applying the global set of sensitivity criteria.

### Graphical User Interfaces

This disclosure above describes various Graphical User Interfaces (GUIs) for implementing various features, processes or workflows. These GUIs can be presented on a variety of electronic devices including but not limited to laptop computers, desktop computers, computer terminals, television systems, tablet computers, e-book readers and smart phones. One or more of these electronic devices can include a touch-sensitive surface. The touch-sensitive surface can process multiple simultaneous points of input, including processing data related to the pressure, degree or position of each point of input. Such processing can facilitate gestures with multiple fingers, including pinching and swiping.

When the disclosure refers to “select” or “selecting” user interface elements in a GUI, these terms are understood to include clicking or “hovering” with a mouse or other input device over a user interface element, or touching, tapping or gesturing with one or more fingers or stylus on a user interface element. User interface elements can be virtual buttons, menus, selectors, switches, sliders, scrubbers, knobs, thumbnails, links, icons, radio buttons, checkboxes and any other mechanism for receiving input from, or providing feedback to a user.

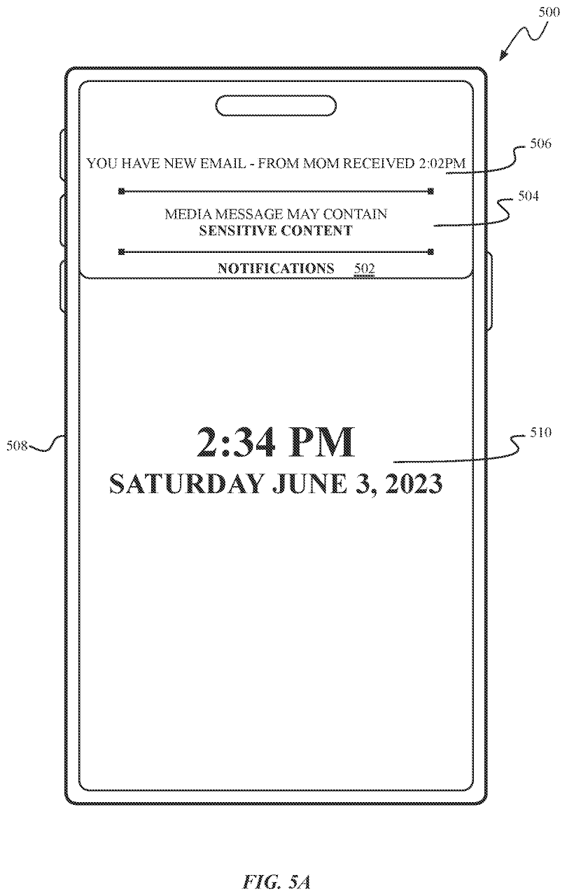

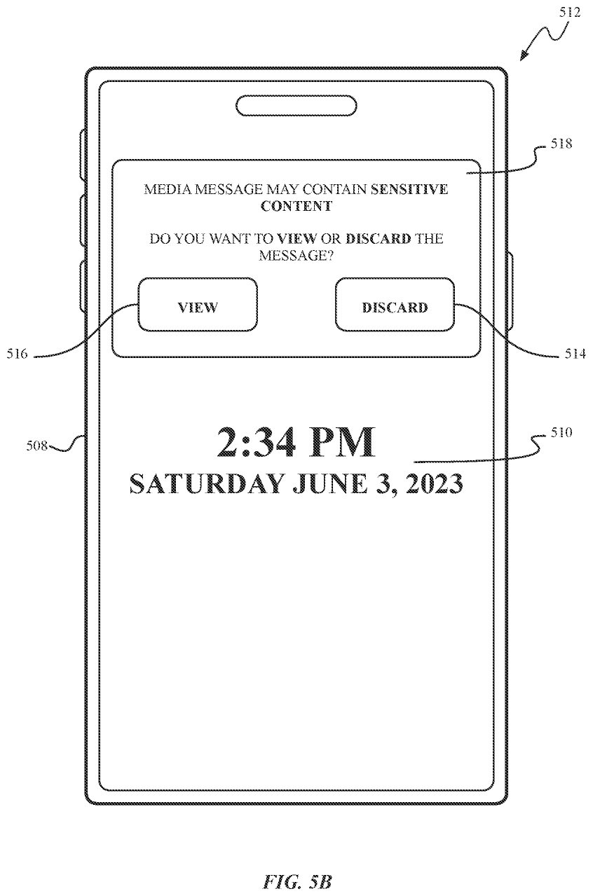

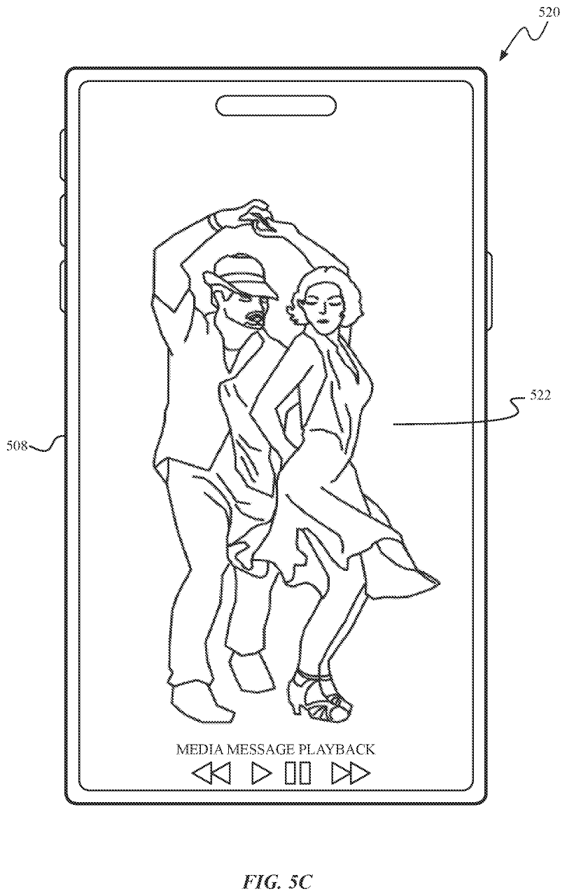

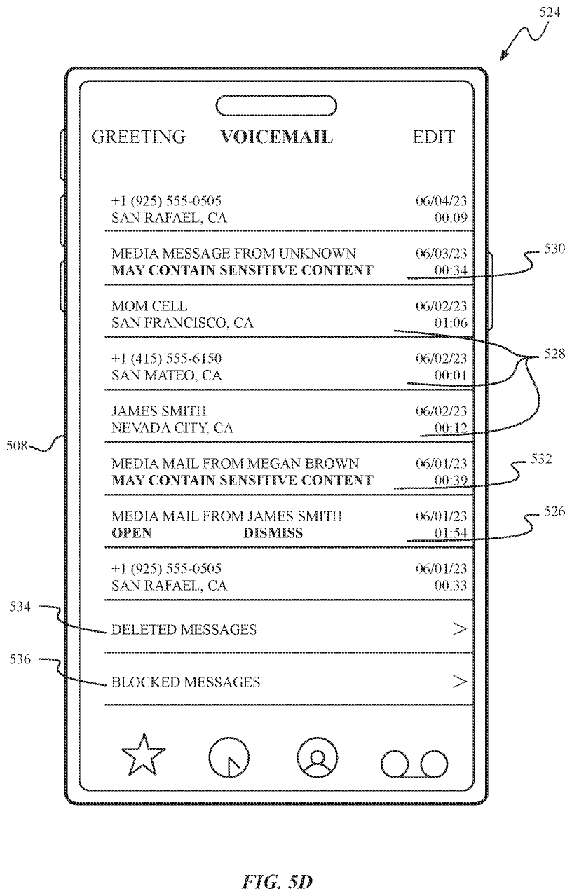

FIGS. 5A-5D show example user interfaces for media message content analysis functionality, in one or more embodiments.

In FIG. 5A, an example user interface 500 is shown displayed to a computing device 508 (e.g., a smartphone) in one or more embodiments. Any type of computing device may be used for interacting with user interface 500, such as a smartphone, tablet computer, wearable device, laptop computer, etc. User interface 500 includes currently displayed content 510 (e.g., a lock screen showing time and date) and a notifications display area 502. The notifications display area 502 may display all notifications enabled on computing device 508, some select notifications (such as mail messages, system messages, etc.), high priority messages, timely messages, and/or user-specified messages. For example, an email-related message 506 is shown in the notifications display area 502, notifying the user of an email from the user's mom.

In response to receiving a media message (such as media mail in response to not answering a call, sent without first calling, etc.), user interface 500 may display a notification 504 in the notifications display area 502 indicating that a media message is available for viewing. Moreover, in one embodiment, in response to sensitive content being detected in the media message, the notification 504 may alert the user to this sensitive content with a relevant message, e.g., “MEDIA MESSAGE MAY CONTAIN SENSITIVE CONTENT.”

Any relevant message or interface element(s) may be displayed in place of or in addition to this message, such as a sender of the media message, a time that the media message was received, a button to playback the media message, a button to delete the media message, a toggle to dismiss the notification 504, etc.

In FIG. 5B, an example user interface 512 is shown displayed to the computing device 508, in one or more embodiments. User interface 512 includes a notification message 518 related to a media message available for viewing on the computing device 508.

In response to sensitive content being detected in the media message, the notification message 518 alerts the user to this sensitive content with a relevant message in an embodiment, e.g., “MEDIA MESSAGE MAY CONTAIN SENSITIVE CONTENT.” In addition, this notification message 518 includes one or more interface elements 514, 516 along with a relevant message that reads “DO YOU WANT TO VIEW OR DISCARD THE MESSAGE?” In one embodiment, interface element 516 allows the user to select to view the media message, while interface element 514 allows the user to discard the media message. In another embodiment, interface element 514 may allow the user to dismiss the message without discarding it entirely. One or both of these interface elements may be displayed. In other embodiments, more or less interface elements may be displayed related to other activities, such as dismissing the media message, storing the media message for later viewing, blocking the sender, reporting the media message as spam, etc. In another embodiment, a selectable interface element may allow the user to choose between a number of options related to the media message, such as delete, open, report, dismiss, etc.

In FIG. 5C, an example user interface 520 is shown displayed to the computing device 508, in one or more embodiments. User interface 520 may be displayed as a result of the user selecting interface element 516 to trigger viewing of the media message. In this embodiment, the media message 522 includes a video of two people dancing. However, the media content of the selected media message 522 will be displayed to the user interface 520 regardless of what the content includes, including any sensitive content.

In FIG. 5D, an example user interface 524 is shown displayed to the computing device 508, in one or more embodiments. User interface 524 shows a voicemail list view, with several voicemails and message mails being displayed. Each item in the list is shown with some relevant information, such as name of the caller, date of the call, length of the message, etc. For example, media mail 526 from James Smith is shown in the voicemail list, along with two selectable interface elements that allow for the user to open the media mail 526, or dismiss the media mail 526, the date of Jun. 1, 2023, and the length of 33 seconds for the media mail 526. In this embodiment, selection of either of these interface elements will cause execution of the associated function in association with the media mail 526. Moreover, since there is no alert or warning associated with this media mail 526, the user may assume that the media mail 526 does not include sensitive content.

User interface 524 also shows several voicemails 528 received from, in order of receipt, James Smith, a number “+1 (415) 555-6150” not included in the user's contact list, and the user's mom. The voicemail list also shows a media message 530 received from an unknown source along with the alert that the media message “MAY CONTAIN SENSITIVE CONTENT” in response to the mobile device 508, or some other device in the network, determining that the media message 530 may include sensitive content, as described herein in various embodiments.

User interface 524 also shows, for example, a media mail from Megan Brown received Jun. 1, 2023 that is 39 seconds in length. Although this media mail 532 is received from a contact in the user's contact list, the user interface 524 indicates that the media mail may include sensitive content as a result of analysis of the media mail 532, for example.

User interface 524 also includes several other selectable interface elements in the voicemail list: deleted messages 534 allowing the user to access messages that have been deleted, and blocked messages 536 that allows the user to access messages that have been blocked by the settings on the computing device 508, for example.

### Privacy

As described above, one aspect of the present technology is the gathering and use of data available from various sources to improve the identification of sensitive content from media messages. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to identify sensitive content from media messages received by a user on a recipient device, and shield the user from the sensitive content and/or notify the user about the sensitive content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of media messaging content analysis services, the present technology can be configured to allow users to select to “opt in” or “opt out” of participation in the collection of personal information data during registration for services or anytime thereafter. In another example, users can select not to provide personal information data for media messaging content analysis services. In yet another example, users can select to limit the length of time personal information data is maintained or entirely prohibit the development of a baseline user profile based on personal information data. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, media messaging content analysis services can be provided by inferring preferences based on non-personal information data or a bare minimum amount of personal information, such as the content being requested by the device associated with a user, other non-personal information available to the media messaging content analysis services, or publicly available information.

### Example System Architecture

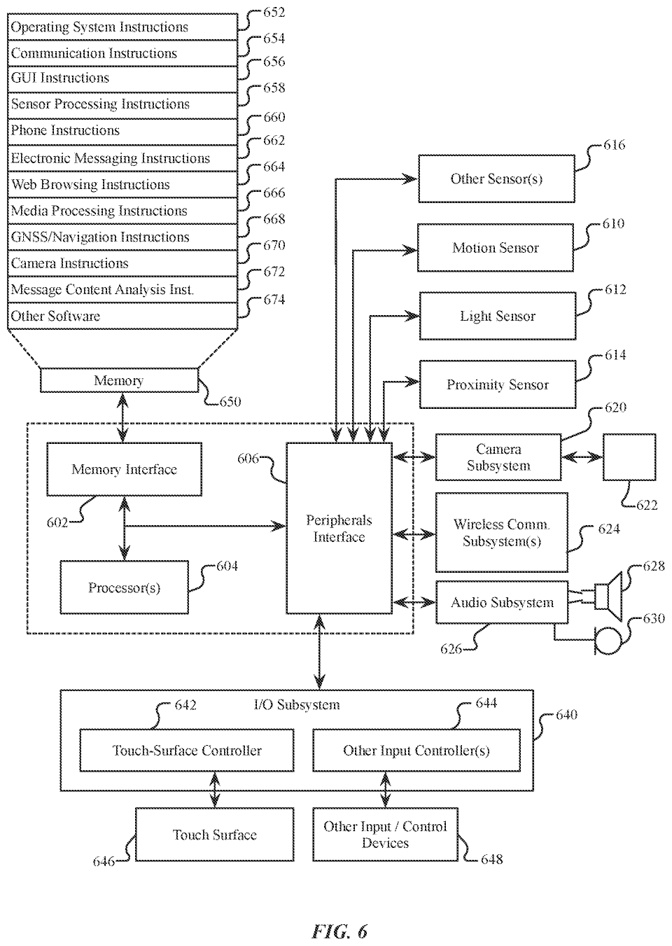

FIG. 6 is a block diagram of an example computing device 600 that can implement the features and processes of FIGS. 1-5D. The computing device 600 can include a memory interface 602, one or more data processors, image processors and/or central processing units 604, and a peripherals interface 606. The memory interface 602, the one or more processors 604 and/or the peripherals interface 606 can be separate components or can be integrated in one or more integrated circuits. The various components in the computing device 600 can be coupled by one or more communication buses or signal lines.

Sensors, devices, and subsystems can be coupled to the peripherals interface 606 to facilitate multiple functionalities. For example, a motion sensor 610, a light sensor 612, and a proximity sensor 614 can be coupled to the peripherals interface 606 to facilitate orientation, lighting, and proximity functions. Other sensors 616 can also be connected to the peripherals interface 606, such as a global navigation satellite system (GNSS) (e.g., GPS receiver), a temperature sensor, a biometric sensor, magnetometer or other sensing device, to facilitate related functionalities.

A camera subsystem 620 and an optical sensor 622, e.g., a charged coupled device (CCD) or a complementary metal-oxide semiconductor (CMOS) optical sensor, can be utilized to facilitate camera functions, such as recording photographs and video clips. The camera subsystem 620 and the optical sensor 622 can be used to collect images of a user to be used during authentication of a user, e.g., by performing facial recognition analysis.

Communication functions can be facilitated through one or more wireless communication subsystems 624, which can include radio frequency receivers and transmitters and/or optical (e.g., infrared) receivers and transmitters. The specific design and implementation of the communication subsystem 624 can depend on the communication network(s) over which the computing device 600 is intended to operate. For example, the computing device 600 can include communication subsystems 624 designed to operate over a GSM network, a GPRS network, an EDGE network, a Wi-Fi or WiMax network, and a Bluetooth™ network. In particular, the wireless communication subsystems 624 can include hosting protocols such that the computing device 600 can be configured as a base station for other wireless devices.

An audio subsystem 626 can be coupled to a speaker 628 and a microphone 630 to facilitate voice-enabled functions, such as speaker recognition, voice replication, digital recording, and telephony functions. The audio subsystem 626 can be configured to facilitate processing voice commands, voice printing and voice authentication, for example.

The I/O subsystem 640 can include a touch-surface controller 642 and/or other input controller(s) 644. The touch-surface controller 642 can be coupled to a touch surface 646. The touch surface 646 and touch-surface controller 642 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 646.

The other input controller(s) 644 can be coupled to other input/control devices 648, such as one or more buttons, rocker switches, thumb-wheel, infrared port, USB port, and/or a pointer device such as a stylus. The one or more buttons (not shown) can include an up/down button for volume control of the speaker 628 and/or the microphone 630.

In one implementation, a pressing of the button for a first duration can disengage a lock of the touch surface 646; and a pressing of the button for a second duration that is longer than the first duration can turn power to the computing device 600 on or off. Pressing the button for a third duration can activate a voice control, or voice command, module that enables the user to speak commands into the microphone 630 to cause the device to execute the spoken command. The user can customize a functionality of one or more of the buttons. The touch surface 646 can, for example, also be used to implement virtual or soft buttons and/or a keyboard.

In some implementations, the computing device 600 can present recorded audio and/or video files, such as MP3, AAC, and MPEG files. In some implementations, the computing device 600 can include the functionality of an MP3 player, such as an iPod™.

The memory interface 602 can be coupled to memory 650. The memory 650 can include high-speed random-access memory and/or non-volatile memory, such as one or more magnetic disk storage devices, one or more optical storage devices, and/or flash memory (e.g., NAND, NOR). The memory 650 can store an operating system 652, such as Darwin, RTXC, LINUX, UNIX, OS X, WINDOWS, or an embedded operating system such as Vx Works.

The operating system 652 can include instructions for handling basic system services and for performing hardware dependent tasks. In some implementations, the operating system 652 can be a kernel (e.g., UNIX kernel). In some implementations, the operating system 652 can include instructions for analyzing media messaging for sensitive content. For example, operating system 652 can implement the media messaging content analysis features as described with reference to FIGS. 1-5D.

The memory 650 can also store communication instructions 654 to facilitate communicating with one or more additional devices, one or more computers and/or one or more servers. The memory 650 can include graphical user interface instructions 656 to facilitate graphic user interface processing; sensor processing instructions 658 to facilitate sensor-related processing and functions; phone instructions 660 to facilitate phone-related processes and functions; electronic messaging instructions 662 to facilitate electronic-messaging related processes and functions; web browsing instructions 664 to facilitate web browsing-related processes and functions; media processing instructions 666 to facilitate media processing-related processes and functions; GNSS/Navigation instructions 668 to facilitate GNSS and navigation-related processes and instructions; and/or camera instructions 670 to facilitate camera-related processes and functions.

The memory 650 can store software instructions 672 to facilitate other processes and functions, such as the media messaging content analysis as described with reference to FIGS. 1-5D.

The memory 650 can also store other software instructions 674, such as web video instructions to facilitate web video-related processes and functions; and/or web shopping instructions to facilitate web shopping-related processes and functions. In some implementations, the media processing instructions 666 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. The memory 650 can include additional instructions or fewer instructions. Furthermore, various functions of the computing device 600 can be implemented in hardware and/or in software, including in one or more signal processing and/or application specific integrated circuits.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What is claimed is:

1. A non-transitory computer readable medium comprising one or more sequences of instructions which, when executed by one or more processors, cause the one or more processors to perform operations comprising:
receiving, by a first recipient device, a first media mail targeting a first user of the first recipient device, the first media mail comprising a first set of media content;
analyzing the first set of media content to determine that the first set of media content meets a first set of one or more sensitivity criteria;
responsive at least to determining that the first set of media content meets the first set of one or more sensitivity criteria, displaying a first alert, on the first recipient device, associated with the first set of one or more sensitivity criteria;
subsequent to displaying the first alert on the first recipient device: receiving, by the first recipient device from the first user, a first user input approving playback of the first set of media content; and
responsive to receiving the first user input approving the playback of the first set of media content, initiating the playback of the first set of media content on the first recipient device.

2. The non-transitory computer readable medium of claim 1, wherein a second device: (a) generated the first set of media content at least by recording sound and/or video detected by the second device subsequent to an unanswered call by the second device to the first device, and (b) transmitted the first set of media content in the first media mail to the first recipient device.

3. The non-transitory computer readable medium of claim 1, wherein the operations further comprise:
concurrently with displaying the first alert on the first recipient device, displaying one or more user interface elements that allow for at least one of: (a) the first user input approving the playback of the first set of media content, or (b) a second user input declining the playback of the first set of media content.

4. The non-transitory computer readable medium of claim 1, wherein the operations further comprise:
displaying, by the first recipient device, a notification corresponding to receipt of the first media mail by the first recipient device in a list of mail notifications, the list of mail notifications comprising notifications associated with one or more of: media mail and voicemail.

5. The non-transitory computer readable medium of claim 4, wherein the operations further comprise:
receiving a second user input selecting the notification corresponding to the receipt of the first media mail,
wherein the first alert is displayed on the first recipient device responsive further to receiving the second user input selecting the notification.

6. The non-transitory computer readable medium of claim 1, wherein the operations further comprise:
receiving, by the first recipient device, a second media mail targeting the first user of the first recipient device, the second media mail comprising a second set of media content;
analyzing the second set of media content to determine that the second set of media content meets the first set of one or more sensitivity criteria;
responsive at least to determining that the second set of media content meets the first set of one or more sensitivity criteria, displaying a second alert on the first recipient device associated with the first set of one or more sensitivity criteria;
subsequent to displaying the second alert on the first recipient device: receiving, by the first recipient device from the first user, a second user input declining playback of the second set of media content; and
responsive to receiving the second user input declining the playback of the first set of media content, refraining from initiating the playback of the second set of media content on the first recipient device.

7. The non-transitory computer readable medium of claim 1, wherein the first set of one or more sensitivity criteria is a set of global sensitivity criteria utilized by a plurality of recipient devices for analyzing respective media mail received at each of the plurality of recipient devices.

8. The non-transitory computer readable medium of claim 1, wherein the first set of one or more sensitivity criteria is a set of user-specific sensitivity criteria, and wherein the operations further comprise:
determining the first set of one or more sensitivity criteria based on a second user input selecting one or more attributes of the first set of one or more sensitivity criteria.

9. The non-transitory computer readable medium of claim 1, wherein the operations further comprise:
receiving, by a second recipient device, a second media mail targeting a second user of the second recipient device, the second media mail comprising the first set of media content;
analyzing, by the second recipient device, the first set of media content to determine that the first set of media content meets a second set of one or more sensitivity criteria, wherein the second set of one or more sensitivity criteria is different than the first set of one or more sensitivity criteria;
responsive at least to the second recipient device determining that the first set of media content meets the second set of one or more sensitivity criteria, displaying a second alert on the second recipient device associated with the second set of one or more sensitivity criteria;
subsequent to displaying the second alert on the second recipient device: receiving, by the second recipient device from the second user, a second user input approving playback of the first set of media content; and
responsive to receiving the second user input approving the playback of the first set of media content, initiating the playback of the first set of media content on the second recipient device.

10. The non-transitory computer readable medium of claim 1, wherein the operations further comprise:
training a machine learning model based on training data to compute sensitivity scores for sets of content, the training data including a first training dataset comprising:
a particular set of media content; and
a label indicating a sensitivity score corresponding to the particular set of media content,
wherein analyzing the first set of media content to determine that the first set of media content meets the first set of one or more sensitivity criteria comprises:
applying the machine learning model to the first set of media content to compute a sensitivity score for the first set of media content; and
determining that the sensitivity score meets the first set of one or more sensitivity criteria;
receiving, from the first user, feedback for the first set of media content; and
updating the machine learning model based on the feedback for the first set of media content.

11. The non-transitory computer readable medium of claim 1, wherein the operations further comprise:
training a machine learning model based on training data to compute sets of sensitivity criteria for users, the training data including a first training dataset comprising:
a first plurality of sets of content;
an approval or disapproval indication, by a particular user, for each particular set of media content in the first plurality of sets of content indicating whether the particular user approved or disapproved of the particular set of media content in the first plurality of sets of content; and
a label, associated with the particular user, defining a particular set of one or more sensitivity criteria for the particular user;
applying the machine learning model to a target dataset, associated with the first user, to compute the first set of one or more sensitivity criteria, the target dataset comprising:
a second plurality of sets of content; and
an approval or disapproval indication, by the first user, for each particular set of media content in the second plurality of sets of content indicating whether the first user approved or disapproved of the particular set of media content in the second plurality of sets of content;
receiving feedback, for the first set of media content, from the first user comprising one of an approval or disapproval for the first set of media content; and
updating the machine learning model based on the feedback for the first set of media content.

12. The non-transitory computer readable medium of claim 1, wherein analyzing the first set of media content to determine that the first set of media content meets the first set of one or more sensitivity criteria comprises analyzing the first set of media content to determine at least one of:
determining that the first set of media content comprises vulgar content;
determining that the first set of media content comprises nudity;
determining that the first set of media content comprises adult-rated content; and
determining that the first set of media content comprises user-specified sensitive content.

13. The non-transitory computer readable medium of claim 1, wherein the operations further comprise:
computing the first set of one or more sensitivity criteria based on a user relationship between (a) the first user and (b) a second user of a second device that transmitted the first media mail to the first user device.

14. The non-transitory computer readable medium of claim 1, wherein the operations further comprise:
computing the first set of or more sensitivity criteria based on whether information associated with a second user, of a second device that transmitted the first media mail to the first user device, is included in a contact list stored by the first user device.

15. A method comprising:
receiving, by a first recipient device, a first media mail targeting a first user of the first recipient device, the first media mail comprising a first set of media content;
analyzing the first set of media content to determine that the first set of media content meets a first set of one or more sensitivity criteria;
responsive at least to determining that the first set of media content meets the first set of one or more sensitivity criteria, displaying a first alert, on the first recipient device, associated with the first set of one or more sensitivity criteria;
subsequent to displaying the first alert on the first recipient device: receiving, by the first recipient device from the first user, a first user input approving playback of the first set of media content; and
responsive to receiving the first user input approving the playback of the first set of media content, initiating the playback of the first set of media content on the first recipient device.

16. The method of claim 15, wherein a second device: (a) generated the first set of media content at least by recording sound and/or video detected by the second device subsequent to an unanswered call by the second device to the first device, and (b) transmitted the first set of media content in the first media mail to the first recipient device.

17. The method of claim 15, further comprising:
concurrently with displaying the first alert on the first recipient device, displaying one or more user interface elements that allow for at least one of: (a) the first user input approving the playback of the first set of media content, or (b) a second user input declining the playback of the first set of media content.

18. The method of claim 15, further comprising:
displaying, by the first recipient device, a notification corresponding to receipt of the first media mail by the first recipient device in a list of mail notifications, the list of mail notifications comprising notifications associated with one or more of: media mail and voicemail.

19. The method of claim 18, further comprising:
receiving a second user input selecting the notification corresponding to the receipt of the first media mail,
wherein the first alert is displayed on the first recipient device responsive further to receiving the second user input selecting the notification.

20. A system comprising:
one or more processors; and
a non-transitory computer readable medium comprising one or more sequences of instructions which, when executed by the one or more processors, cause the one or more processors to perform operations comprising:
receiving, by a first recipient device, a first media mail targeting a first user of the first recipient device, the first media mail comprising a first set of media content;
analyzing the first set of media content to determine that the first set of media content meets a first set of one or more sensitivity criteria;
responsive at least to determining that the first set of media content meets the first set of one or more sensitivity criteria, displaying a first alert, on the first recipient device, associated with the first set of one or more sensitivity criteria;
subsequent to displaying the first alert on the first recipient device: receiving, by the first recipient device from the first user, a first user input approving playback of the first set of media content; and
responsive to receiving the first user input approving the playback of the first set of media content, initiating the playback of the first set of media content on the first recipient device.
